(19) United States
(12) Patent Application Publication
(10) Pub. No.: US 2003/0192732 A1
(43) Pub. Date: Oct. 16, 2003

(54) System and method for controlling operation of a loader

(76) Inventor: James Warkentine, Niverville (CA)

Correspondence Address: ADE & COMPANY, 1700-360 MAIN STREET, WINNIPEG, MB, R3C3Z3, CA

(21) Appl. No.: 10/411,292

(22) Filed: Apr. 11, 2003

(30) Foreign Application Priority Data
Apr. 11, 2002 (CA) 2,381,479

(51) Int. Cl. B60K 28/00

(52) U.S. Cl. 180/286; 414/685

(57) ABSTRACT

A method of controlling a loader operation using a control system is provided. The system is intended for use on a conventional skid steer loader of the type having either a cab with an integral door for operator access to the cab or a door kit installed thereon. The system includes a door position sensing means for sensing a position of the door of the cab. A disabling means of the system is provided for disabling a lift mechanism of the loader in response to detection that door of the cab is not fully closed by the door position sensing means. The disabling means may comprise a mechanism for coupling the door position sensing means to an existing disabling system of the lift of the vehicle.

### FIELD OF THE INVENTION

The present invention relates to method of controlling operation of a loader, and more particularly to a control system for disabling a lift mechanism of the loader in response to a prescribed condition.

### BACKGROUND

Certain models of skid steer loaders, having a lift mechanism supporting a bucket on a front end thereof, include a cab with an integral door supported on a front side thereof or may be arranged to accept a door kit for supporting a door on the front side thereof. On certain models of skid steer loaders however, the lift arms supporting the bucket are known to collide with the door if the door is inadvertently left open. Collision of the lift arms with the door may cause considerable damage to the loader as well as potentially injuring an operator of the loader.

Various safety devices have been proposed for vehicles to disable the vehicle in the event that a door is left open, however none of these devices appear to be suitably arranged for use on a loader. Examples of safety devices for detecting if a door of a vehicle is open are found in U.S. Pat. No. 2,876,856 to Greene, U.S. Pat. No. 2,360,227 to Hemphil and U.S. Pat No. 2,182,426 to Courcier. Each of these devices teaches disabling the engine of the vehicle, which in the instance of a loader may not necessarily prevent collision of the lift arms of a loader with an open door thereof. Furthermore disabling the engine of the loader causes undesirable damage and wear on the engine of the loader.

### SUMMARY

According to one aspect of the present invention there is provided a method of controlling operation of a loader having a cab with a door for operator access to the cab and a lift mechanism for raising and lowering a load supported thereon, the method comprising:

sensing a position of the door of the cab; and

disabling the lift mechanism of the loader in response to detection that the door of the cab is not fully closed.

By disabling only the lift mechanism of the loader, undesirable wear and potential damage to the engine is avoided as would otherwise occur if the engine of the loader were disabled. By sensing a position of the door to determine if the door is not fully closed, the present invention ensures that a collision of the lift arms of a loader with the open door of a cab of the loader would not occur, thus avoiding any costs associated with damage to the door as well as protecting the operator from potential injury due to such a collision.

Disabling the lift mechanism may be accomplished by activating an existing lift disabling mechanism of the loader, and more particularly by disabling operation of hydraulics of the loader.

When a door switch is provided for sensing a position of the door, the method preferably includes connecting the door switch to an existing operator restraint detecting switch operatively connected to the existing lift disabling mechanism of the loader.

A selective connector on the door switch is preferably provided, in which the method includes mating the selective connector to an existing connector coupling the operator restraint detecting switch to the lift disabling mechanism.

The loader preferably comprises a skid steer loader.

An electrical switch may be provided which is supported about a frame of the door of the cab for sensing a position of the door of the cab. This may be accomplished by providing a bracket selectively supporting the electrical switch about the frame of the door.

According to a second aspect of the present invention there is provided a control system for a loader having a cab with a door for operator access to the cab and a lift mechanism for raising and lowering a load supported thereon, the system comprising:

door position sensing means for sensing a position of the door of the cab; and

a disabling means for disabling the lift mechanism of the loader in response to detection that the door of the cab is not fully closed by the door position sensing means.

According to a further aspect of the present invention there is provided a loader comprising:

a cab with a door for operator access to the cab;

a lift mechanism for raising and lowering a load supported thereon;

door position sensing means for sensing a position of the door of the cab; and

a disabling means for disabling the lift mechanism of the loader in response to detection that the door of the cab is not fully closed by the door position sensing means.

The door position sensing means preferably comprises an electrical switch.

There may be provided a bracket supporting the electrical switch adjacent a door frame surrounding the door of the loader.

The disabling means preferably comprises a connector connecting the door position sensing means to a conventional lift disabling mechanism of the loader.

The connector may comprise a mating connector mated with a conventional connector of the lift disabling mechanism of the loader.

The connector preferably comprises a mating connector connected in series with a operator restraint detecting switch connector of the lift disabling mechanism of the loader.

The disabling means may be arranged to interrupt hydraulic operation of the lift mechanism of the loader in response to detection that the door of the cab is not fully closed by the door position sensing means.

### BRIEF DESCRIPTION OF THE DRAWINGS

In the accompanying drawings, which illustrate an exemplary embodiment of the present invention:

FIG. 1 is an isometric view of a loader having the control system supported thereon.

FIG. 2 is an isometric view of the components of the control system for connection to the existing connectors of a loader.

FIG. 3 is a schematic view of the components of the control system.

### DETAILED DESCRIPTION

Referring to the accompanying drawings, there is illustrated a control system generally indicated by reference numeral 10. The control system 10 is arranged for controlling operation of a conventional skid steer loader 12.

In the illustrated embodiment, the skid steer loader 12 comprises a commercially available loader by New Holland™. The loader includes a pair of lift arms 14 which are pivotally supported on opposing sides of the loader which are hydraulically actuated to lift and lower a bucket 16 arranged to support a load therein. Typically, a brace 18 is provided which extends between the parallel lift arms 14 which extend forwardly from the loader.

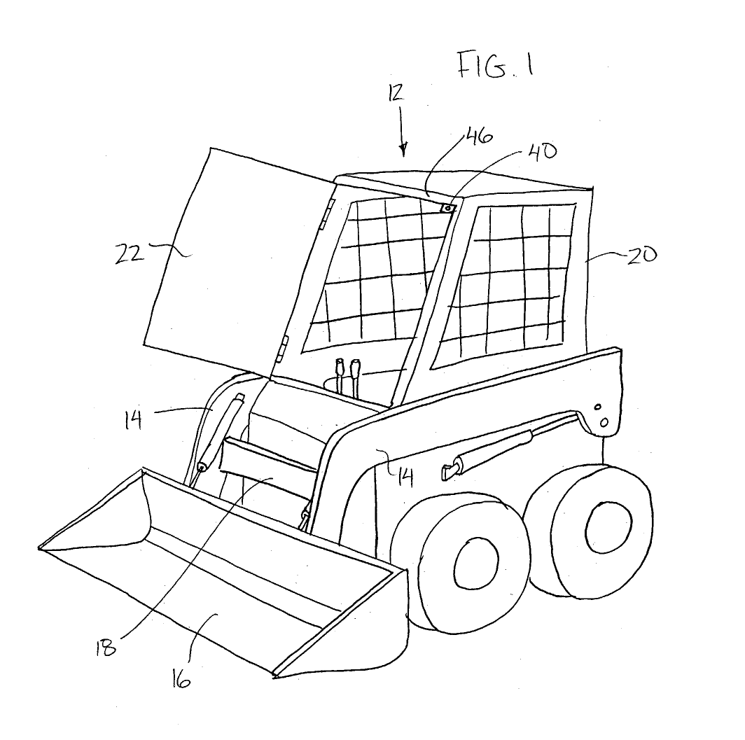

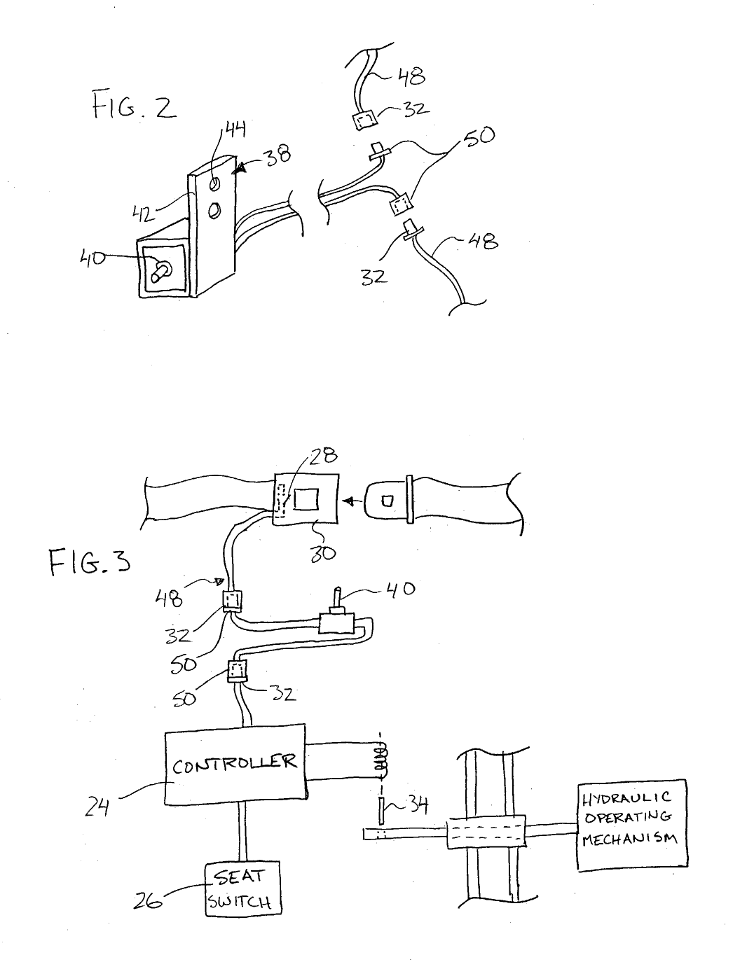

A cab 20 is provided on the loader for housing an operator of the loader therein. The cab includes a door 22 supported on a front side thereof for pivotal movement between a respective fully open position and a fully closed position. The door 22 may comprise an integral weather resistant door or demolition door for protecting the operator, or may alternatively comprise a door kit for subsequent attachment to the cab 20 of the loader. In practice when the door 22 is pivoted into an open position projecting forwardly from the loader as illustrated in FIG. 1, the lift arms 14 and particularly the brace 18 connected therebetween are arranged to collide with the door 22 if the door is inadvertently left open.

The loader 12 further includes a controller 24 arranged to disable operation of the lift arms 14 upon a prescribed condition being detected. Detection of the prescribed condition is determined by a control algorithm, a seat switch 26 which determines whether an operator is seated on a seat of the cab 20 and an operator restraint detecting switch in the form of seatbelt switch 28 arranged to detect when the seatbelt is properly latched together. The seatbelt switch 28 is housed within the female seatbelt connector 30 and is arranged to be coupled to the controller 24 by suitable existing mating male and female electrical connectors 32. The controller 24 is connected to a solenoid actuated pin 34 which interlocks with the hydraulic operating mechanism of the loader to seize the hydraulic operating components of the loader, thus disabling operation of the lift arms.

The control system 10 according to the present invention includes a bracket 38 which is arranged to support a door switch 40 of the system on the cab of the loader. The bracket 38 generally comprises a flat plate 42 having a pair of fastener apertures 44 therein for suitable securement of the door switch 40 to a door frame 46 of the cab of the loader using suitable fasteners so that the door switch 40 is suitable oriented to be engaged by the door 22 when the door is fully closed.

The door switch 40 includes an electrical switch housed therein which is closed upon engagement of the door switch with a fully closed door 22 of the cab. The electrical switch of the door switch 40 is connected to a seatbelt circuit 48 of the loader which includes the mating connectors 32 connecting the seatbelt switch 28 to the controller 24. The control system 10 includes respective mating male and female connectors 50 which are arranged to mate with the respective male and female mating connectors 32 of the loader 12 so that the electrical switch of the door switch 40 is connected in series with the seatbelt circuit 48 of the loader.

In this arrangement, when the door 22 of the loader is open, the electrical switch of the door switch 40 remains open for interrupting the seatbelt switch so that the controller 24 of the loader responds in a similar manner to detection of the seatbelt switch 28 being opened, to have the effect of activating the solenoid actuated pin 34 to lock hydraulic operation of the loader thus disabling the lift arms 14. The mating male and female connectors 50 of the system 10 permit installation of the door switch 40 within the existing seatbelt circuit of the loader to disable the lift arms of the loader using an existing disabling mechanism of the loader to stop hydraulic operation of the loader only, while permitting continued operation of the engine of the loader.

The door switch 40 may be provided with a keyed override switch permitting access to only authorized persons, although this precaution is likely unnecessary as there is little motivation for operators of such loaders to disable such a switch. The addition of a door switch and related circuitry for interconnection with the existing disabling mechanism of the vehicle does not provide any added inconvenience to the operators of the loader, but rather serves as a useful reminder which is desirable to the operators to ensure that the lift arms of the loader do not collide with an open door 22 on the cab of the loader. As described above operation of the lift arms is only permitted if the door 22 is fully closed as detected by the door switch 40 of the system.

While one embodiment of the present invention has been described in the foregoing, it is to be understood that other embodiments are possible within the scope of the invention. In further embodiments for instance, the control system may include its own integral disabling mechanism arranged to connect to hydraulics of the loader for disabling operation of the lift arms of the loader without relying on existing systems of the loader.

The door switch 40, in further embodiments, may be replaced by other conventional types of door proximity sensing switches, including coded magnetic switches and the like. Also, the particular construction of the switch may be varied to include a weather or dust resistant, resilient sealing member which surrounds the switch to protect the inner working components thereof.

When the control system 10, as described above, is applied to other types of skid steer loaders, the system may be connected to other existing disabling mechanisms of the loaders, for example the rigid lap bar operator restraint in loaders manufactured by Caterpillar™. In this arrangement, the door switch is similarly coupled in series with an operator restraint detecting switch to disable the loader in the same manner as when the loader detects that the operator restraint is not in place. A separate disabling mechanism employed solely by the control system 10 may also be used on such further examples of skid steer loaders.

The invention is to be considered limited solely by the scope of the appended claims.

1. A method of controlling operation of a loader having a cab with a door for operator access to the cab and a lift mechanism for raising and lowering a load supported thereon, the method comprising:
sensing a position of the door of the cab; and
disabling the lift mechanism of the loader in response to detection that the door of the cab is not fully closed.

2. The method according to claim 1 including disabling the lift mechanism by activating an existing lift disabling mechanism of the loader.

3. The method according to claim 2 including providing a door switch for sensing a position of the door and connecting the door switch to an existing operator restraint detecting switch operatively connected to the existing lift disabling mechanism of the loader.

4. The method according to claim 3 including providing a selective connector on the door switch and mating the selective connector to an existing connector coupling the operator restraint detecting switch to the lift disabling mechanism.

5. The method according to claim 1 including disabling the lift mechanism by disabling operation of hydraulics of the loader.

6. The method according to claim 1 wherein the loader comprises a skid steer loader.

7. The method according to claim 1 including providing an electrical switch and supporting the electrical switch about a frame of the door of the cab for sensing a position of the door of the cab.

8. The method according to claim 7 including providing a bracket selectively supporting the electrical switch about the frame of the door.

9. A control system for a loader having a cab with a door for operator access to the cab and a lift mechanism for raising and lowering a load supported thereon, the system comprising:
door position sensing means for sensing a position of the door of the cab; and
a disabling means for disabling the lift mechanism of the loader in response to detection that the door of the cab is not fully closed by the door position sensing means.

10. The control system according to claim 9 wherein the door position sensing means comprises an electrical switch.

11. The control system according to claim 10 wherein there is provided a bracket for supporting the electrical switch adjacent a door frame surrounding the door of the loader.

12. The control system according to claim 9 wherein the disabling means comprises a connector arranged to connect the door position sensing means to an existing lift disabling mechanism of the loader.

13. The control system according to claim 12 wherein the connector comprises a conventional connector arranged to mate with an existing connector of the lift disabling mechanism of the loader.

14. A loader comprising:
a cab with a door for operator access to the cab;
a lift mechanism for raising and lowering a load supported thereon;
door position sensing means for sensing a position of the door of the cab; and
a disabling means for disabling the lift mechanism of the loader in response to detection that the door of the cab is not fully closed by the door position sensing means.

15. The control system according to claim 14 wherein the door position sensing means comprises an electrical switch.

16. The control system according to claim 15 wherein there is provided a bracket supporting the electrical switch adjacent a door frame surrounding the door of the loader.

17. The control system according to claim 14 wherein the disabling means comprises a connector connecting the door position sensing means to a conventional lift disabling mechanism of the loader.

18. The control system according to claim 17 wherein the connector comprises a mating connector mated with a conventional connector of the lift disabling mechanism of the loader.

19. The control system according to claim 17 wherein the connector comprises a mating connector connected in series with an operator restraint detecting switch connector of the lift disabling mechanism of the loader.

20. The control system according to claim 14 wherein the disabling means interrupts hydraulic operation of the lift mechanism of the loader in response to detection that the door of the cab is not fully closed by the door position sensing means.
